(19) United States
(12) Patent Application Publication
(10) Pub. No.: US 2016/0088052 A1
(43) Pub. Date: Mar. 24, 2016

(54) INDEXING MOBILE DEVICE CONTENT USING VEHICLE ELECTRONICS

(71) Applicant: GM Global Technology Operations LLC, Detroit, MI (US)

(72) Inventors: Karen Juzswik, Ypsilanti, MI (US); Lakshmi V. Thanayankizil, Rochester Hills, MI (US); David P. Pop, Garden City, MI (US); Fan Bai, Ann Arbor, MI (US)

(21) Appl. No.: 14/495,345

(22) Filed: Sep. 24, 2014

(51) Int. Cl. H04L 29/06; H04W 4/04; G06F 17/30; H04W 4/00

(52) U.S. Cl. CPC H04L 65/608; H04L 65/4084; H04W 4/008; H04W 4/046; G06F 17/3002

(57) ABSTRACT

A communication system and various methods using that communication system, including a method of providing mobile device media content in a vehicle. One method includes the steps of: identifying one or more mobile devices at the vehicle using vehicle electronics that include a vehicle multi-tainment unit (VMU); determining whether any of the one or more mobile devices are connected via a non-legacy short-range wireless communication (SRWC) link; when the VMU determines a connected mobile device from among the one or more mobile devices, then indexing at the VMU media content on the connected mobile device; receiving a request from a vehicle user for media content; and providing the requested media content via vehicle electronics.

### TECHNICAL FIELD

The present invention relates to indexing media content at a vehicle head unit that is received from one or more mobile devices.

### BACKGROUND

Conventional vehicle head units enable vehicle users to play audio, e.g., via analog or digital AM/FM radio stations and/or stored media (such as compact discs and solid state devices). More recently, vehicle head units provide other data including XM or satellite radio and GPS data via on-board navigation units.

### SUMMARY

According to an embodiment of the invention, there is provided a method of providing mobile device media content in a vehicle. The method includes the steps of: identifying one or more mobile devices at the vehicle using vehicle electronics that include a vehicle multi-tainment unit (VMU); determining whether any of the one or more mobile devices are connected via a non-legacy short-range wireless communication (SRWC) link; when the VMU determines a connected mobile device from among the one or more mobile devices, then indexing at the VMU media content on the connected mobile device; receiving a request from a vehicle user for media content; and providing the requested media content via vehicle electronics.

According to another embodiment of the invention, there is provided a method of providing mobile device media content in a vehicle. The method includes the steps of: configuring a vehicle multi-tainment unit (VMU) to operate using a short range wireless communication (SRWC) protocol capable of pre-association; pre-associating with the VMU a first mobile device near the vehicle via the SRWC protocol; when the first mobile device is connected with the VMU via the SRWC protocol, then indexing at the VMU media content on the first mobile device; when the first mobile device is not connected with the VMU via the SRWC protocol, then: connecting the first mobile device with the VMU and indexing at the VMU media content on the first mobile device; and providing the media content via one or more vehicle electronics components, wherein the components include the VMU, a vehicle display, and a vehicle audio system.

According to another embodiment of the invention, there is provided a computer program product that includes a non-transitory computer readable medium for vehicle head unit. One or more software programs may be stored on the computer readable medium that include program instructions, and the program instructions may include: pre-associating the vehicle head unit with a mobile device using a non-legacy short range wireless communication (SRWC) protocol; connecting with the mobile device via SRWC; indexing at the head unit media content metadata stored on the mobile device; and providing media content based on a vehicle user request.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is a block diagram depicting a vehicle head unit wirelessly interacting with a mobile device;

FIG. 3 illustrates a flow diagram of a method according to the present disclosure; and

FIG. 4 illustrates an example of a media listing displayed on vehicle electronics.

### DETAILED DESCRIPTION OF THE ILLUSTRATED EMBODIMENT(S)

Short range wireless communication (SRWC) protocols enable a number of wireless services in modern vehicles. For example, a cellular network that is in communication with a mobile device may wirelessly connect with a vehicle's electronics (via a SRWC link) and after the connection is established, the mobile device may provide multimedia-type services to in-vehicle electronics allowing that media content to be provided to all occupants of the vehicle. Moreover, the same procedure may be repeated allowing multiple, different mobile devices to wirelessly connect to the in-vehicle electronics and provide different media content to the occupants as well. According to the present disclosure, the development of newer SRWC protocols (such as Wi-Fi Direct) now enables in-vehicle electronics to pre-associate with mobile devices that are equipped with the same new(er) SRWC protocol capability and thereby identify in advance of any SRWC connection which device(s) might provide the previously mentioned media content. In addition, once these in-vehicle electronics and mobile devices have wirelessly connected, the in-vehicle electronics may index metadata related to the media content stored on the respective mobile device(s) without user-prompting (e.g., automatically). According to at least one implementation, this indexing may occur prior to a vehicle occupant requesting to access the mobile devices' media content via the in-vehicle electronics (i.e., an occupant who is also an operator of the mobile device). One embodiment described herein includes the in-vehicle electronics storing a listing of the mobile devices which may provide such media content (e.g., those that have been previously pre-associated) and a listing of all the media content on one or more previously connected mobile devices. In this manner, the in-vehicle electronics may provide the vehicle occupants a current list of available media, when the respective mobile devices are present in the vehicle. In addition, as the in-vehicle electronics may pre-associate with the mobile devices and also may index the devices' media content automatically, the methods described herein may expedite providing the media content to vehicle occupants—thereby providing the vehicle occupants a more desirable vehicle experience.

### Communications System—

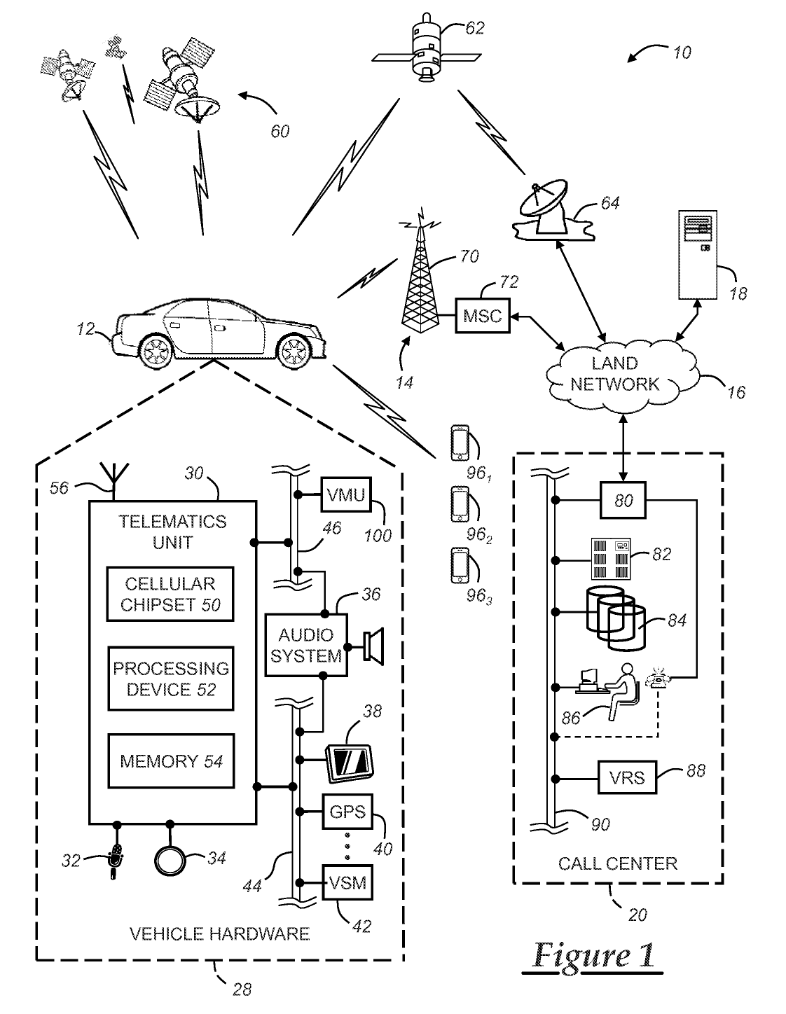

With reference to FIG. 1, there is shown an operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, a vehicle head unit or vehicle multi-tainment unit (VMU) 100, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM or CDMA standards and thus includes a standard cellular chipset 50 for voice communications like hands-free calling, a wireless modem for data transmission, an electronic processing device 52, one or more digital memory devices 54, and a dual antenna 56. It will be appreciated that GSM or CDMA standards illustrate merely exemplary implementations and other standards are also possible (e.g., LTE). It should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, EDGE, and LTE. Wireless networking between the vehicle and other networked devices (including one or more mobile devices 96₁, 96₂, 96₃) can also be carried out using telematics unit 30. For this purpose, telematics unit 30 can be configured to communicate wirelessly according to one or more suitable wireless protocols. Examples of wireless network(s) include both cellular networks (as previously described) but also short range wireless communication (SRWC). SRWC is intended to be construed broadly and may include one or more suitable wireless protocols including: any Wi-Fi standard (e.g., IEEE 802.11); Wi-Fi Direct, Bluetooth, or other suitable peer-to-peer standard; wireless infrared transmission; WiMAX; ZigBee™; and/or various combinations thereof. This list is merely meant to provide examples and is not intended to be limiting.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

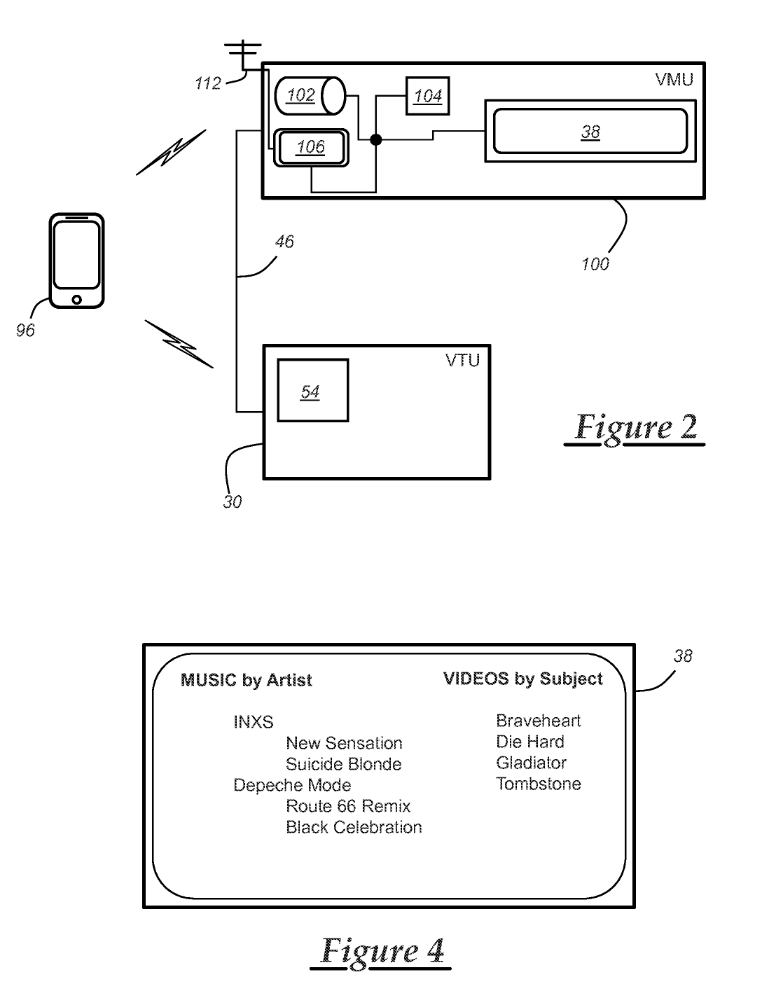

The vehicle electronics 28 may also include the vehicle multi-tainment unit (VMU) 100 which may be a separate module or may include some of the vehicle electronics previously discussed (e.g., the audio system 36, the visual display 38, etc.) (see also FIG. 2). Display examples of the VMU include interactive displays in the vehicle instrument panel, interactive displays embedded within the backing of vehicle seating or the vehicle headliner, and other interactive vehicle devices/displays that are portable. Thus, in some instances, the VMU 100 may be integrated (e.g., a fixture) within the vehicle 12 and in some circumstances it may be detachably fixed or detachably tethered (e.g., usable both inside and outside the vehicle).

As shown in both FIGS. 1 and 2, the VMU 100 may include all suitable electronics, software, etc. for providing vehicle entertainment and vehicle infotainment services to the vehicle users and/or occupants including memory 102 coupled to a processor or processing device 104. The VMU 100 may be coupled to (and in communication with) the telematics unit 30; e.g., by wire (via bus 46) or wirelessly using wireless chipset 106 or both.

Additionally, the chipset 106 may enable short range wireless communication (SRWC) using antenna 112 to other communication devices such as mobile devices 96₁, 96₂, 96₃ (FIG. 1) or simply mobile device 96 (as shown in FIG. 2). According to at least one implementation, the VMU 100 may be operably configured for a non-legacy SRWC protocol or standard; e.g., such as Wi-Fi Direct, or other 802.11 standard. As used herein, a legacy standard includes Bluetooth. This configuration may include a wireless chipset (e.g., such as chipset 106) being capable of such communication, as well as software or firmware in the VMU 100 being configured to utilize non-legacy standards. In addition, as will be described in greater detail below, the VMU 100 also may be configured to pre-associate with other non-legacy wireless devices, as well as to automatically index such non-legacy wireless devices (e.g., obtaining metadata therefrom). Examples of non-legacy wireless devices may include mobile devices 96₁, 96₂, 96₃.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

As also shown in FIG. 1, the operating environment may further include one or more mobile devices 96 (e.g., 96₁, 96₂, 96₃). The mobile devices 96 may be electronic devices which may be used to make mobile telephone calls across a wide geographic area where transmissions are facilitated by the wireless carrier system 14 (i.e., when the mobile device is connected to the wireless carrier system).

The mobile devices 96 may further include: hardware, software, and/or firmware enabling cellular telecommunications and communications via short-range wireless communication as well as other mobile device applications. Connectivity with mobile devices 96 may utilize both legacy and non-legacy standards. For purposes of the present disclosure, a legacy standard may include USB and Bluetooth (e.g., USB being an example of a legacy (wired) connection and Bluetooth being an example of a legacy (wireless) connection). For purposes of the present disclosure, a mobile device supporting the 802.11 wireless standard (i.e., Wi-Fi) and Wi-Fi Direct are examples of non-legacy connection standards. Of course, some connection standards newer or more modern than Wi-Fi or Wi-Fi Direct may be considered non-legacy connection standards as well.

The hardware of the mobile devices 96 may comprise: a processor and memory (e.g., non-transitory computer readable medium configured to operate with the processor) for storing the software, firmware, etc. The mobile device processor and memory may enable various software applications, which may be preinstalled or installed by the user (or manufacturer) (e.g., having a software application or graphical user interface or GUI). One commercial implementation of a vehicle-mobile device application may be RemoteLink™, enabling a vehicle user to communicate with the vehicle 12 and/or control various aspects or functions of the vehicle—e.g., among other things, allowing the user to remotely lock/unlock vehicle doors, turn the vehicle On/Off, check the vehicle tire pressures, fuel level, oil life, etc. RemoteLink™ may also allow the user to connect with the call center 20 or the call center advisor 86 at any time.

Another commercially available implementation of a vehicle-mobile device application is MirrorLink™, enabling a mobile device to “mirror” what is located on the mobile device display to the vehicle's visual display 38 (e.g., on the VMU 100) and incorporate mobile device input/output (I/O) with in-vehicle I/O (e.g., steering wheel controls, VMU 100 controls, etc.). MirrorLink™ may utilize some forms of SRWC to accomplish this mirroring. Thus, in at least one example, mobile devices 96 may use MirrorLink™ with the VMU 100 (and/or the telematics unit 30).

Yet another commercially available implementation of a vehicle-mobile device application is Miracast™, enabling a mobile device to stream video and/or photos/images from the mobile device to the vehicle's visual display 38 (e.g., on the VMU 100). Miracast™ may utilize some forms of SRWC to accomplish this streaming, including peer-to-peer connectivity such as Wi-Fi Direct. Thus, in at least one example, mobile devices 96 may use Miracast™ with the VMU 100 (and/or the telematics unit 30).

The hardware of the mobile devices 96 also may include a display, a keypad (e.g., push button and/or touch screen), a microphone, one or more speakers, motion-detection sensors (such as accelerometers, gyroscopes, etc.), and a camera.

In addition to the aforementioned features, some mobile devices may support additional services and/or functionality such as short messaging service (SMS or texts), multimedia messaging service (MMS), email, internet access, as well as business and gaming applications.

Non-limiting examples of the mobile device 96 include a cellular telephone, a personal digital assistant (PDA), a Smart phone, a personal laptop computer or tablet computer having two-way communication capabilities, a netbook computer, a notebook computer, or any suitable combinations thereof. The mobile devices 96 may be used inside or outside of a mobile vehicle (such as the vehicle 12 shown in FIG. 1), and may be coupled to the vehicle by wire or wirelessly (e.g., using short range wireless communication). The mobile devices 96 also may be configured to provide services according to a subscription agreement with a third-party facility or wireless/telephone service provider. It should be appreciated that various service providers may utilize the wireless carrier system and that the service provider of the telematics unit 30 may not necessarily be the same as the service provider of the mobile devices 96.

The mobile devices 96 and the vehicle 12 may be used together by person(s) known as vehicle users or occupants such as a vehicle driver and/or one or more vehicle passengers. However, the vehicle user does not need to have ownership of the mobile device 96 or the vehicle 12 (e.g., the vehicle user may be an owner or a licensee of either or both).

### Method—

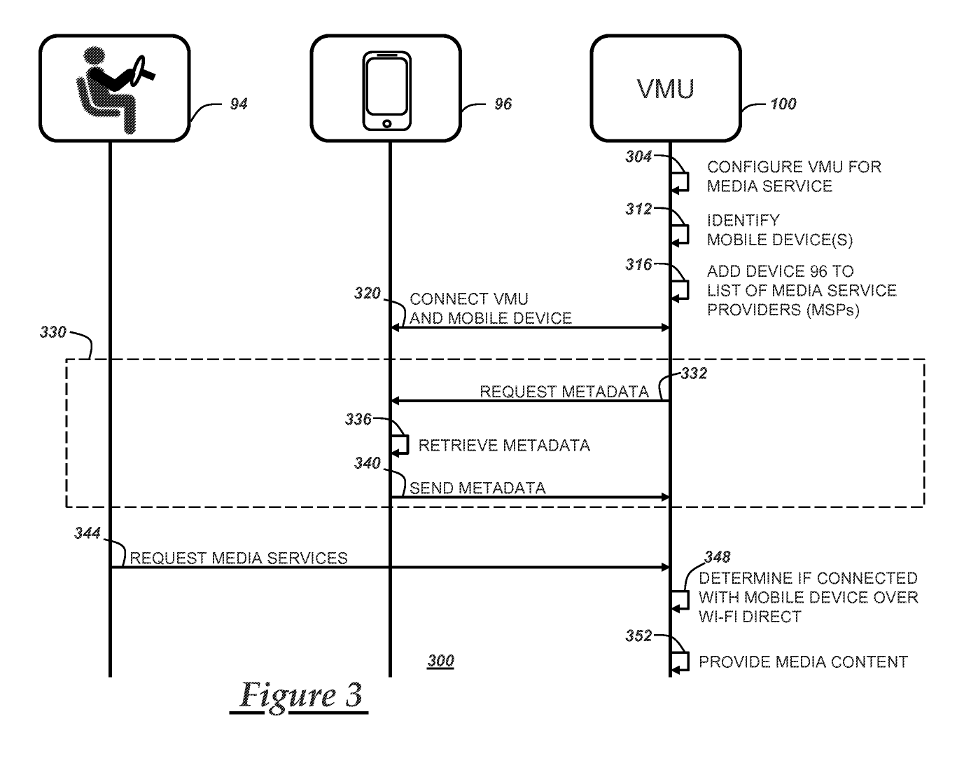

Turning now to FIG. 3, there is shown one embodiment of a method 300 that implements at least some of the components of the above-described communication system 10; more specifically, FIG. 3 illustrates one method of providing media services to vehicle occupants via a non-legacy SRWC standard. For example, the method 300 is illustrated using a Wi-Fi Direct standard; although other non-legacy standards could also be used. In part, the media services are provided by indexing media metadata stored on the mobile device 96. This indexing is performed by the VMU 100; by performing the method, the VMU is able to more quickly and efficiently provide the media contents of one or mobile devices 96 to the occupants upon their request.

Providing media services includes providing of any media content from the mobile device(s) 96 to the VMU 100. Therefore, the mobile device(s) 96 may be considered media service providers (MSPs). The term media content should be construed broadly to include video data, audio data, and/or multi-media data; moreover, media content may pertain to information data (e.g., news, finance, advertising, education, science, industry, government, just to name a few information examples) and/or entertainment data (e.g., music, movies, gaming, television, just to name a few entertainment examples). The media content may be stored on any suitable memory in the mobile device(s) 96 or may be any content accessible by the mobile device(s) (e.g., accessible via the cloud or internet).

In all instances, the media content relevant to method 300 may have or be associated with metadata which may be acquired by the VMU 100, as will be described in more detail below.

The method begins with step 304—configuring the VMU 100 for media services associated with mobile device 96. The configuration may include installation of and operability of application firmware and/or software at the VMU 100 (e.g., stored on memory 102 and having instructions executable by processor 104). For example, the instructions may include executing some or all of the remaining steps of the method described herein. In at least one implementation, the software application is suitably operable to: pre-associate with one or more mobile devices 96 that have Wi-Fi Direct capability (i.e., non-legacy devices); acquire and maintain a listing (or list) of non-legacy devices (e.g., a listing of potential MSPs); connect via Wi-Fi Direct with one or more mobile devices on the listing; request and receive metadata (i.e., index metadata) from the one or more mobile devices; and upon receiving an indication (at the VMU) that a user 94 requests media services, providing a listing of the available media or media services based on the metadata from the connected mobile devices. Providing the listing may occur via the vehicle electronics 28 (e.g., via the VMU 100 which may include the audio system 36 and/or the display 38). The software application may further include determining that some pre-associated mobile devices 96 are not connected and then connecting with the mobile device(s) in order to obtain, among other things, media metadata. These instructions are not an exhaustive list nor do all the instructions need to be performed. Moreover, one or more of the instructions may be performed in a different order. Following step 304, the method 300 may proceed to step 312.

In step 312, the VMU 100 may identify non-legacy mobile device(s) 96—e.g., those configured to be Wi-Fi Direct capable. As will be appreciated by skilled artisans, in a Wi-Fi Direct environment (and according to the Wi-Fi Direct specification), internet protocol (IP) based network(s) are created between Wi-Fi Direct devices thereby allowing existing discovery methods to be operable just as they are over a wireless LAN. Wi-Fi Direct also permits a pre-association technique or discovery method thereby permitting Wi-Fi Direct devices the ability to discover other similarly configured devices and obtain limited information about those devices prior to association or connection (and before having an IP address). Thus, as part of step 312, the VMU 100 may identify Wi-Fi Direct mobile devices 96 in or near the vehicle 12. As part of the identifying step, the VMU 100 may acquire a unique identifier associated with the identified mobile device 96. The unique identifier may be any suitable number, letter, character, etc. or combination thereof (e.g., a serial number of the device 96 or a component thereof, a MAC address, an international mobile subscriber identity (IMSI), just to name a few examples). In addition to the unique identifier, the VMU 100 may acquire other limited information from the mobile device 96 during pre-association. After step 312, the method 300 may proceed to step 316.

In step 316, the VMU 100 may compile a list of identified mobile devices 96; i.e., a listing of devices identified in step 312. These mobile devices may be considered a group of media service providers (MSPs) suitable for performing the method(s) described herein. As will be explained below, from the mobile devices 96 on this list the VMU 100 may obtain media metadata in a manner more efficiently than conventional means—thereby improving the vehicle user's in-vehicle experience. Following step 316, the method may proceed to step 320.

In step 320, the VMU 100 and mobile device 96 may connect according to a non-legacy standard or protocol—e.g., according to Wi-Fi Direct. Connection procedures will not be detailed here, as such procedures are known to skilled artisans.

Following step 320, the method may perform indexing step 330. As illustrated in FIG. 3, indexing includes the VMU 100 capturing relevant metadata from the mobile device 96. Step 330 may comprise several sub-steps (332, 336, and 340). In step 332, the VMU may wirelessly request metadata from the mobile device via the Wi-Fi Direct connection. In at least one example, this request may be directed to media-related metadata or metadata related to media content. Examples of requested metadata may include metadata types or parameters such as a title, an author, a subject, a category, a date, a file type, a file size, etc. For example, if the media content is an audio file, the metadata could be the title “New Sensation,” the author “INXS,” the subject “music,” the category “New Wave,” the date “19 Oct. 1987,” a file type “MP3,” and the file size 2.12 MB. This of course is merely an example; the actual metadata and type of metadata will vary depending on the media content. Sub-step 336 may occur at the mobile device as the device 96 retrieves or gathers the requested metadata. And in sub-step 340, the mobile device 96 may send or transmit wirelessly the retrieved metadata to the VMU 100 where it may be received and stored in memory 102.

It should be appreciated that the identifying step 312, the connecting step 320, and the indexing step 330 may be performed prior to a vehicle occupant 94 entering the vehicle 12 or immediately (or nearly so) after the occupant enters the vehicle. For example, many modern vehicles have remote starting capability. Steps 312, 320, and 330 may be performed as the occupant approaches the vehicle 12 with the mobile device 96 on his/her person. Or even if the vehicle is started when the occupant is in the vehicle's cabin, this may occur immediately or soon after start-up. Other instances might include indexing prior to vehicle start-up. In any case, these steps often may be performed for one or more mobile devices prior to the occupant requesting media services in the next step (344) which follows.

Also, in some instances, the indexing step 330 may include recording the time and data of the indexing. This information may be stored in VMU memory 102 and be used at a later time to determine whether the metadata received is up-to-date. After the indexing step, the method may proceed to step 344.

In step 344, the VMU 100 may receive an indication that the vehicle occupant 94 has requested media services—more specifically, media services which are available using the mobile device 96. The indication may be received as a user request or selection via any of the vehicle electronics 28; e.g., via a pushbutton 34 (e.g., on the VMU) or via a touch screen input (e.g., via the display 38 or VMU) or a voice control input via the microphone 32 or any other suitable means for conveying an electrical signal to the VMU 100.

Upon receipt of the indication (step 344), the method may proceed to step 348 and determine that the VMU 100 and the mobile device 96 are connected (or are still connected). If the connection exists currently, then the method proceeds to step 352.

In step 352, the VMU 100 provides the requested media content to the vehicle occupants. For example, the VMU via the Wi-Fi Direct connection receives any suitable data associated with the requested file (e.g., the entire file or the streaming file) and provides it via the vehicle electronics. For example, if the file was the audio file “New Sensation,” then the file is played to the vehicle occupants using the audio system 36. Of course, if the file were a video or multimedia file, it might be provided via the display 38 and/or audio system 36, etc.

If in step 348, the VMU 100 determines that the mobile device 96 is not connected (or is no longer connected), the VMU may connect (or at least attempt to connect) via Wi-Fi Direct and then perform the indexing step 330 and/or providing the media content (step 352).

In another embodiment, the method may receive an indication that the vehicle occupant desires media services and provide a list or listing of available media. For example, instead of the indication resulting in the providing of a specific file, the indication may result in providing a media content listing (i.e., all of the media files available on any of the mobile devices currently connected). This listing will vary depending upon which of the mobile devices (e.g., 96₁, 96₂, 96₃) are connected. The metadata may be used to group or categorize the files. An example of the media content listing is shown in FIG. 4.

The method(s) discussed above may be performed as one or more computer programs executable by the VMU 100 to cause the system to perform the method. The various method related data may be stored in any suitable memory (e.g., memory 102 at the VMU or any other suitable memory). The computer program may exist as one or more software program(s) comprised of program instructions in source code, object code, executable code or other formats; firmware program(s); or hardware description language (HDL) files. Any of the above can be embodied on a computer usable or readable medium, which include one or more storage devices or articles. Exemplary computer usable storage devices (such as memory 102) include conventional computer system RAM (random access memory), ROM (read only memory), EPROM (erasable, programmable ROM), EEPROM (electrically erasable, programmable ROM), and magnetic or optical disks or tapes. It is therefore to be understood that the methods may be at least partially performed by any electronic device(s) capable of executing the above-described functions.

Thus there has been described various methods to pre-associate a particularly configured vehicle multi-tainment unit (VMU) with particularly configured mobile devices and thereafter connect these devices to the VMU according to a non-legacy short range wireless communication protocol or standard (such as Wi-Fi and Wi-Fi Direct). The methods include generating a list of pre-associated mobile devices (or previously connected mobile devices) and a list of media content on each of these non-legacy mobile devices. The media content may be acquired by the VMU by an indexing method that captures media metadata from each of the respective devices. The methods described herein ultimately may provide the content to occupants of the vehicle upon their request, and in some instances prior to providing the content, the method may provide a list or collection of the available media content (e.g., based on which mobile devices are currently connected).

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of providing mobile device media content in a vehicle, comprising the steps of:
(a) identifying one or more mobile devices at the vehicle using vehicle electronics that include a vehicle multi-tainment unit (VMU);
(b) determining whether any of the one or more mobile devices are connected via a non-legacy short-range wireless communication (SRWC) link;
(c) when the VMU determines a connected mobile device from among the one or more mobile devices, then indexing at the VMU media content on the connected mobile device;
(d) receiving a request from a vehicle user for media content; and
(e) providing the requested media content via vehicle electronics.

2. The method of claim 1, wherein the identifying step includes a pre-association technique that does not require connecting with the one or more mobile devices.

3. The method of claim 2, further comprising:
(f) storing an identifier associated with each of the one or more mobile devices on memory of the VMU; and
(g) based on the stored identifiers, creating a list of the one or more mobile devices capable of providing media content via the non-legacy SRWC.

4. The method of claim 1, wherein step (c), indexing the media content, includes:
(c1) transmitting a request for media metadata to the connected mobile device; and
(c2) receiving a response to the request that includes media metadata.

5. The method of claim 4, wherein the media metadata includes at least one of the following parameters: a title, an author, a subject, a category, a date, a file type, or a file size.

6. The method of claim 1, wherein the non-legacy SRWC link uses one of the following standards: an 802.11 standard or a Wi-Fi Direct standard.

7. The method of claim 1, wherein the vehicle electronics further include: a vehicle display and a vehicle audio system.

8. A method of providing mobile device media content in a vehicle, comprising the steps of:
(a) configuring a vehicle multi-tainment unit (VMU) to operate using a short range wireless communication (SRWC) protocol capable of pre-association;
(b) pre-associating with the VMU a first mobile device near the vehicle via the SRWC protocol;
(c) when the first mobile device is connected with the VMU via the SRWC protocol, then indexing at the VMU media content on the first mobile device;
(d) when the first mobile device is not connected with the VMU via the SRWC protocol, then:
(d1) connecting the first mobile device with the VMU; and
(d2) indexing at the VMU media content on the first mobile device; and
(e) providing the media content via one or more vehicle electronics components, wherein the components include the VMU, a vehicle display, and a vehicle audio system.

9. The method of claim 8, further comprising step (f): receiving an indication from a vehicle user of a desire to receive the media content of the first mobile device prior to step (e).

10. The method of claim 8, wherein steps (c) and (d2) include capturing media metadata associated with media content stored on the first mobile device.

11. The method of claim 10, wherein steps (c) and (d2) further comprise recording the time and date of the indexing.

12. The method of claim 10, wherein the media metadata includes at least one of the following parameters: a title, an author, a subject, a category, a date, a file type, or a file size.

13. The method of claim 8, wherein step (b) further includes receiving at the VMU a unique identifier associated with the first mobile device.

14. The method of claim 13, further comprising step (g): adding the unique identifier of the first mobile device to a listing of media service providers (MSPs) stored at the VMU.

15. The method of claim 14, further comprising repeating steps (b), (c), (d), and (e) for a second mobile device, wherein the media content of step (e) is from the first mobile device or the second mobile device.

16. The method of claim 15, further comprising step (h): presenting to a vehicle user a media content listing available via the first and second mobile devices and based on the indexing at the VMU.

17. The method of claim 8, wherein the SRWC protocol includes one of: an 802.11 standard or a Wi-Fi Direct standard.

18. A computer program product, comprising: a non-transitory computer readable medium for vehicle head unit, comprising one or more software programs stored on the computer readable medium that include program instructions that include:
pre-associating the vehicle head unit with a mobile device using a non-legacy short range wireless communication (SRWC) protocol;
connecting with the mobile device via SRWC;
indexing at the head unit media content metadata stored on the mobile device; and
providing media content based on a vehicle user request.

19. A computer program product configured for the mobile device of claim 18, comprising: a non-transitory computer readable medium, comprising one or more software programs stored on the computer readable medium that include program instructions that include:
pre-associating with the vehicle head unit using the non-legacy SRWC protocol; and
permitting the head unit to index the media content metadata stored on the mobile device.

20. The computer program product of claim 18, wherein the non-legacy SRWC is an 802.11 standard or a Wi-Fi Direct standard.
